(19) United States
(12) Patent Application Publication
(10) Pub. No.: US 2025/0026409 A1
(43) Pub. Date: Jan. 23, 2025

(54) CAGE/CHASSIS INTEGRATED AIR SUPPLY SYSTEM

(71) Applicant: Geiser, Inc., Phoenix, AZ (US)

(72) Inventor: Sean Geiser, Phoenix, AZ (US)

(21) Appl. No.: 18/766,199

(22) Filed: Jul. 8, 2024

Related U.S. Application Data
(60) Provisional application No. 63/513,950, filed on Jul. 17, 2023.

(51) Int. Cl. B62D 21/17; A42B 3/28

(52) U.S. Cl. CPC B62D 21/17; A42B 3/281; A42B 3/286

(57) ABSTRACT

A cage/chassis integrated air supply system is provided. The system includes a cage/chassis for a vehicle formed of at least one hollow supply tube forming a part of the cage/chassis. The system includes at least one air input port coupled to one end of the at least one hollow supply tube; at least one air output port coupled to another end of the at least one hollow supply tube; an air supply coupled to the at least one air input port; and at least one output hose coupled to the at least one air output port. The at least one output hose is configured to couple to a forced air helmet, wherein the air supply is configured to supply air into the at least one air input port, through the at least one hollow supply tube, through the at least one air output port and through the at least one output hose.

### CROSS REFERENCE TO RELATED APPLICATION(S)

This application claims priority to U.S. Provisional Patent Application entitled “CAGE/CHASSIS INTEGRATED AIR SUPPLY SYSTEM,” Ser. No. 63/513,950, filed Jul. 17, 2023, the disclosure of which is hereby incorporated entirely herein by reference.

### BACKGROUND OF THE INVENTION

### Technical Field

This invention relates generally to an air supply system for a vehicle, and more particularly to a cage/chassis integrated air supply system.

### State of the Art

Drivers that race vehicles are often in need of having a supply of air for various reasons. One of the main reasons includes the ability to breath clean or filtered air during a race. Ambient air may be filled with dust, exhaust and other contaminants that may be inhaled by a driver, a passenger, or the like during a race. The air supply system includes an air supply and hoses that delivers clean or filtered air to a driver or passenger wearing a forced air helmet or the equivalent. These air supply systems are lacking in the ability to keep hoses hidden and to utilize components already a part of the vehicle that is being driven.

Accordingly, there is a need for a cage/chassis integrated air supply system for use with a forced air helmet.

### SUMMARY OF THE INVENTION

An embodiment includes an integrated air supply system for a cage or chassis of a vehicle comprising: at least one hollow supply tube forming a part of the cage or chassis of the vehicle; at least one air input port coupled to one end of the at least one hollow supply tube; at least one air output port coupled to another end of the at least one hollow supply tube; an air supply coupled to the at least one air input port; and at least one output hose coupled to the at least one air output port, the at least one output hose configured to couple to a forced air helmet, wherein the air supply is configured to supply air into the at least one air input port, through the at least one hollow supply tube, through the at least one air output port and through the at least one output hose.

The cage or chassis may comprise a first hollow supply tube, a second hollow supply tube and a third hollow supply tube. The at least one air input port may be coupled to one end of the first hollow supply tube. The at least one air output port may comprise at least one rear air output port and at least one front air output port. The at least one rear air output port may be coupled to the second hollow supply tube. The at least one front air output port may be coupled to the third hollow supply tube.

The at least one air input port may comprise an input port internal aperture. The input port internal aperture may be fluidly connected to a first inner hollow portion of the first hollow supply tube. The at least one rear air output port may comprise a rear output port aperture fluidly connected to a second inner hollow portion of the second hollow supply tube. The at least one front air output port may comprises a front output port aperture fluidly connected to a third inner hollow portion of the third hollow supply tube. The at least one hollow supply tube may be supported by at least one support tube. The air supply may be coupled to the at least one air input port by an input hose having an air filter.

Another embodiment includes a method of supplying air to a forced air helmet comprising supplying air into at least one air input port and through at least one hollow supply tube, the at least one hollow supply tube forming a portion of a cage or chassis of a vehicle; directing the air through the at least one hollow supply tube and through at least one air output port; and flowing the air into a forced air helmet.

The cage or chassis may comprise a first hollow supply tube, a second hollow supply tube and a third hollow supply tube. The method may further comprise coupling the at least one air input port to one end of the first hollow supply tube. The at least one air output port may comprise at least one rear air output port and at least one front air output port. The method may further comprise coupling the at least one rear air output port to the second hollow supply tube. The method may further comprise coupling the at least one front air output port to the third hollow supply tube. The at least one air input port may comprise an input port internal aperture. The method further may comprise fluidly connecting the input port internal aperture to a first inner hollow portion of the first hollow supply tube.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a perspective view of a cage/chassis having a cage/chassis integrated air supply system, according to an embodiment;

FIG. 2 is a perspective view of a cage/chassis having a cage/chassis integrated air supply system, according to an embodiment;

FIG. 3 is a perspective partially section view of a cage/chassis having a cage/chassis integrated air supply system, according to an embodiment;

FIG. 4 is a perspective partially section view of a cage/chassis having a cage/chassis integrated air supply system, according to an embodiment;

FIG. 5 is a perspective view of an air supply coupled to a cage/chassis integrated air supply system, according to an embodiment;

FIG. 6 is a perspective view of a filter of an air supply coupled to a cage/chassis integrated air supply system, according to an embodiment;

FIG. 7 is a perspective view of rear air output ports and hoses of an air supply coupled to a cage/chassis integrated air supply system, according to an embodiment;

FIG. 8 is a perspective view of front air output ports and hoses of an air supply coupled to a cage/chassis integrated air supply system, according to an embodiment;

FIG. 9 is a perspective view of front air output ports and hoses of an air supply coupled to a cage/chassis integrated air supply system, according to an embodiment; and

FIG. 10 is a block diagram of steps of a method of supplying air to a forced air helmet, according to an embodiment.

### DETAILED DESCRIPTION OF EMBODIMENTS OF THE INVENTION

As discussed above, embodiments of the present invention relate to a cage/chassis integrated air supply system, wherein the system operates to supply air to a forced air helmet through one or more hollow tubes forming at least a portion of the cage/chassis.

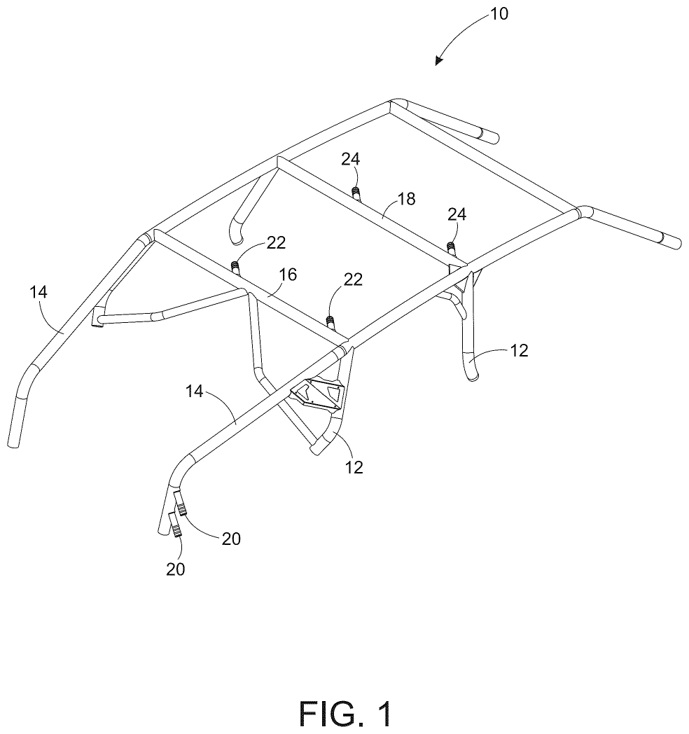

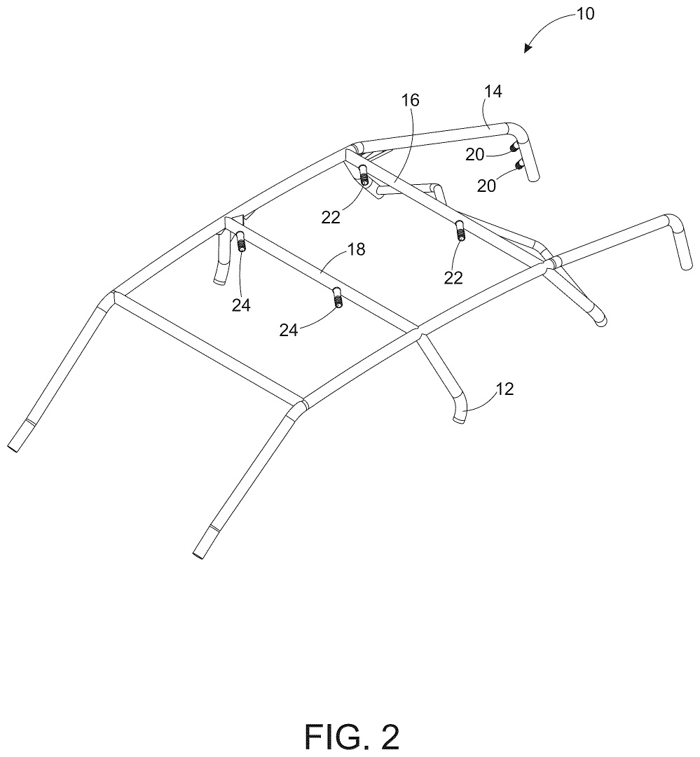

Referring to FIGS. 1-4, depicted is a cage/chassis integrated air supply system 10 according to an embodiment. The system 10 comprises a cage/chassis formed of various tubes, including a first hollow supply tube 14, a second hollow supply tube 16 and a third hollow supply tube 18 and other support tubes 12. The system 10 also comprises air input ports 20, rear air output ports 22, and front air output ports 24. The air input ports 20 are coupled to first hollow supply tube 14. The rear air output ports 22 are coupled to the second hollow supply tube 16. The front air output ports 24 are coupled to the third hollow supply tube 18.

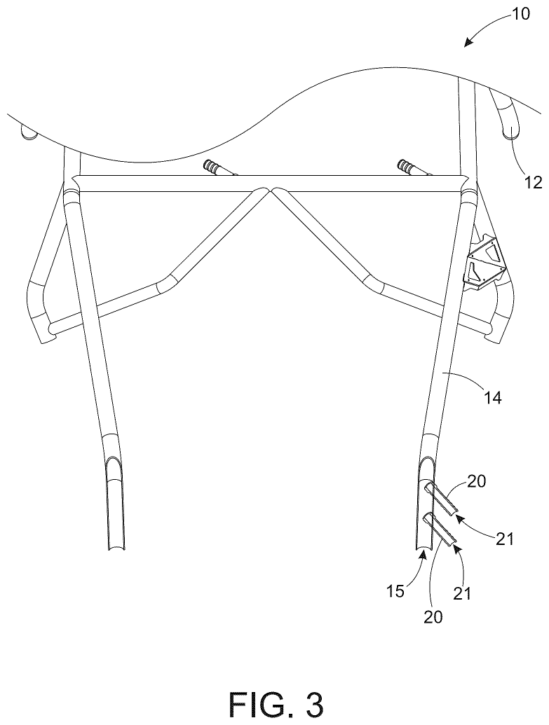

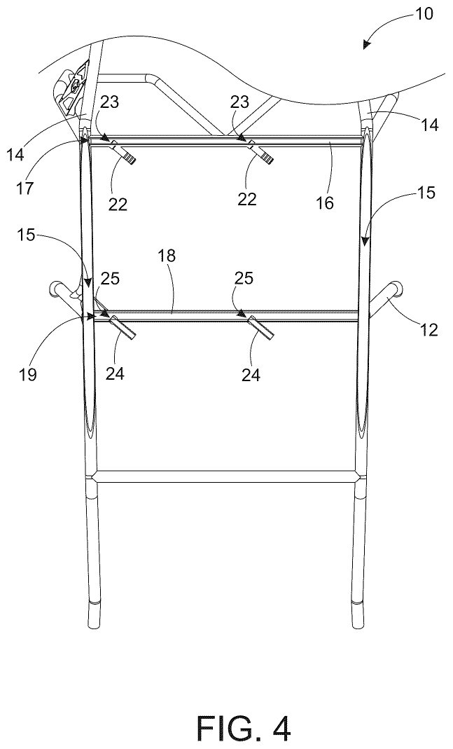

Referring to FIGS. 3 and 4, the air input ports 20 include internal aperture 21 that is fluidly connected to a first inner hollow portion 15 of the first hollow supply tube 14. This allows air to flow into the first hollow supply tube 14 through the air input ports 20. The rear air output ports 22 include internal aperture 23 that is fluidly connected to a second inner hollow portion 17 of the second hollow supply tube 16. This allows air to flow through the second hollow supply tube 16 through the rear output ports 22. The front air output ports 24 include internal aperture 25 that is fluidly connected to a third inner hollow portion 19 of the third hollow supply tube 18. This allows air to flow through the third hollow supply tube 18 through the front air output ports 24.

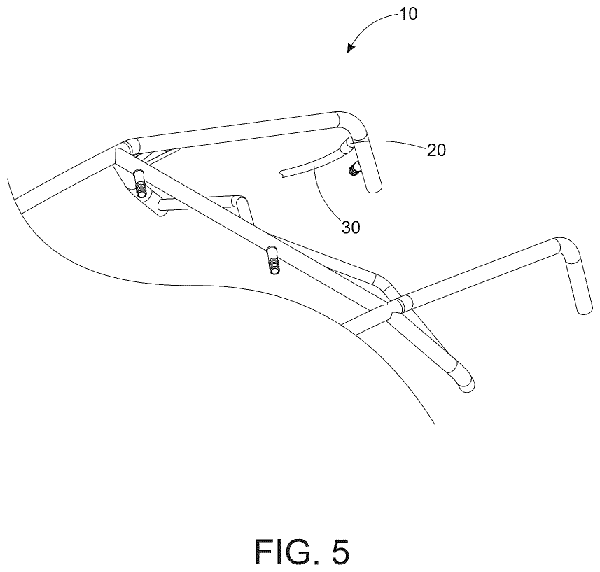

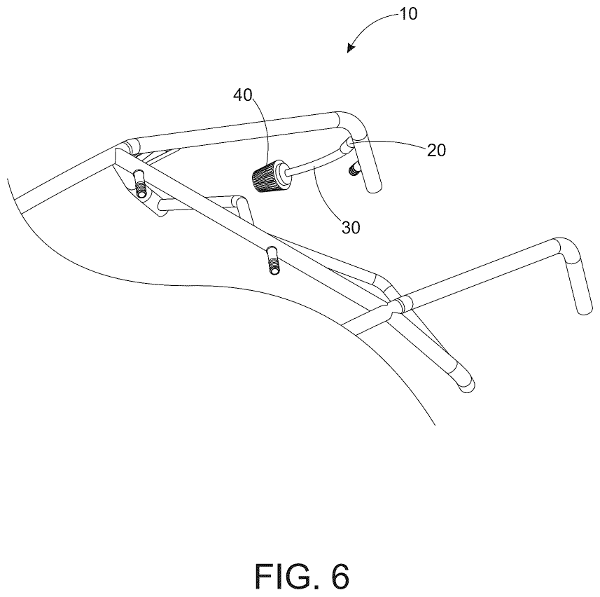

Referring to FIGS. 5-6, the air supply is coupled to one of the air input ports 20 by input hose 30. The air supply comprises an air filter 40, wherein the air filter 40 operates to filter air that is drawn into the air supply.

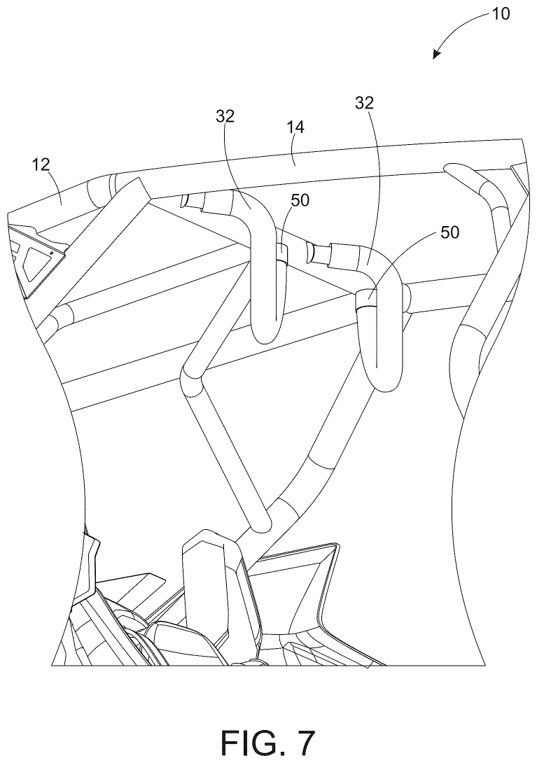

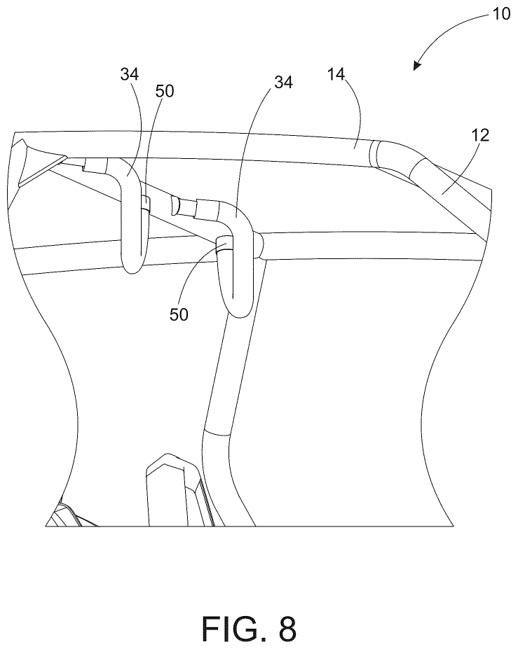

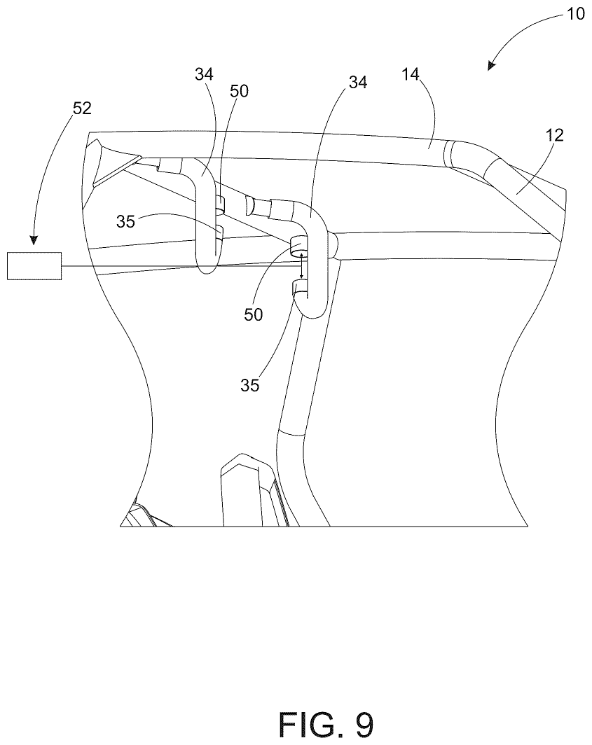

Referring to FIGS. 7-9, rear output hoses 32 coupled to the rear air output ports 22, wherein the rear output hoses 32 are configured to couple to forced air helmets 52 of driver and/or passengers. Front output hoses 34 coupled to the front air output ports 24, wherein the front output hoses 34 are configured to couple to the forced air helmets 52. The front output hoses 34 and the rear output hoses 32 may have ends with respective couplings 35 that couple to storage posts 50 when not in use. The ends may be removed from the posts and coupled to the forced air helmets 52.

In operation, the air supply is coupled to the first hollow supply tube 14 through air input ports 20 and operation of the air supply pumps air into the first hollow supply tube 14. During operation, it may be necessary to pressurize the system 10, wherein the air supply continues to pump air into the hollow tubes forming the cage/chassis until the system reaches an equilibrium of pressure. This allows consistent flow of air through the rear air output ports 22 and the front air output ports 24. When air is desired to be used with a forced air helmet, the user removes the rear output hose 32 or the front output hose 34 from the storage post 50 and couples it to an inlet of the forced air helmet. The air pumped into the first hollow supply tube 14 may then flow through the second hollow supply tube 16 and/or the third hollow supply tube 18 and out of one or more of the rear air output ports 22 and/or the front air output ports 24. It will be understood that air may be supplied to all of the output ports at the same time in order to supply air to multiple forced air helmets at the same time, thereby allowing the driver and all passengers to benefit from the filtering of air and supplying clean, filtered air to all people racing in the vehicle.

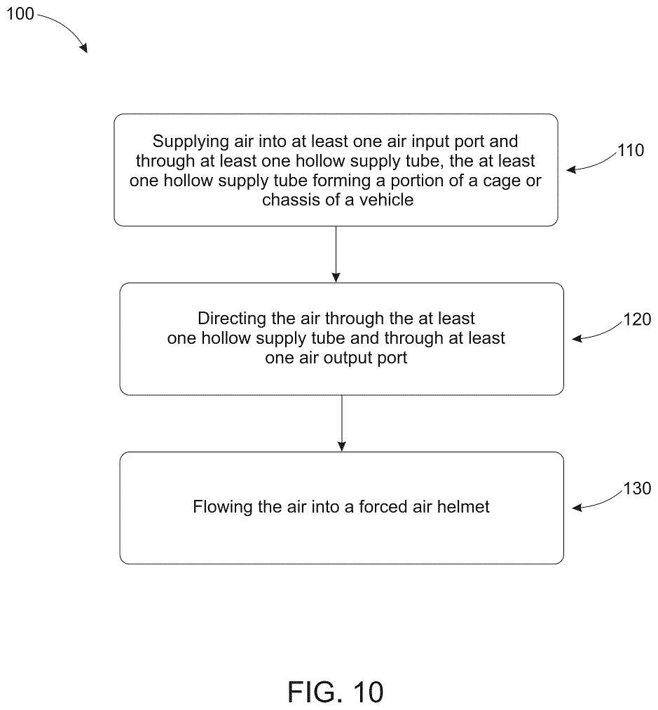

FIG. 10 shows a method of supplying air to a forced air helmet. Method 100 comprises: supplying air into at least one air input port and through at least one hollow supply tube, the at least one hollow supply tube forming a portion of a cage or chassis of a vehicle (Step 110); directing the air through the at least one hollow supply tube and through at least one air output port (Step 120); and flowing the air into a forced air helmet (Step 130).

The cage or chassis comprises a first hollow supply tube, a second hollow supply tube and a third hollow supply tube. The method further comprises coupling the at least one air input port to one end of the first hollow supply tube. The at least one air output port comprises at least one rear air output port and at least one front air output port. The method further comprises coupling the at least one rear air output port to the second hollow supply tube. The method further comprises coupling the at least one front air output port to the third hollow supply tube. The at least one air input port comprises an input port internal aperture. The method further comprises fluidly connecting the input port internal aperture to a first inner hollow portion of the first hollow supply tube.

It will be understood that in embodiments, the vehicle is an offroad vehicle such as, but not limited to a UTV. While it is shown that the vehicle is a UTV in the drawings, some embodiments may be adapted to use in other types of vehicles.

It will be understood that implementations are not limited to the specific components disclosed herein, as virtually any components consistent with the intended operation of a method and/or system implementation for a cage/chassis integrated air supply system may be utilized. Accordingly, for example, although particular hollow tubes, air input and output ports, hoses and other components are disclosed, such components may comprise any shape, size, style, type, model, version, class, grade, measurement, concentration, material, weight, quantity, and/or the like consistent with the intended operation of a method and/or system implementation for a cage/chassis integrated air supply system. Implementations are not limited to uses of any specific components, provided that the components selected are consistent with the intended operation of a method and/or system implementation for a cage/chassis integrated air supply system.

Accordingly, the components defining any a cage/chassis integrated air supply system implementation may be formed of any of many different types of materials or combinations thereof that can readily be formed into shaped objects provided that the components selected are consistent with the intended operation of a cage/chassis integrated air supply system implementation. For example, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining any cage/chassis integrated air supply system implementation may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. An integrated air supply system for a cage or chassis of a vehicle comprising:
at least one hollow supply tube forming a part of the cage or chassis of the vehicle;
at least one air input port coupled to one end of the at least one hollow supply tube;
at least one air output port coupled to another end of the at least one hollow supply tube;
an air supply coupled to the at least one air input port; and
at least one output hose coupled to the at least one air output port, the at least one output hose configured to couple to a forced air helmet, wherein the air supply is configured to supply air into the at least one air input port, through the at least one hollow supply tube, through the at least one air output port and through the at least one output hose.

2. The integrated supply system of claim 1, wherein the cage or chassis comprises a first hollow supply tube, a second hollow supply tube and a third hollow supply tube.

3. The integrated air supply system of claim 2, wherein the at least one air input port is coupled to one end of the first hollow supply tube.

4. The integrated air supply system of claim 3, wherein the at least one air output port comprises at least one rear air output port and at least one front air output port.

5. The integrated air supply system of claim 4, wherein the at least one rear air output port is coupled to the second hollow supply tube.

6. The integrated air supply system of claim 5, wherein the at least one front air output port is coupled to the third hollow supply tube.

7. The integrated air supply system of claim 6, wherein the at least one air input port comprises an input port internal aperture.

8. The integrated air supply system of claim 7, wherein the input port internal aperture is fluidly connected to a first inner hollow portion of the first hollow supply tube.

9. The integrated air supply system of claim 8, wherein the at least one rear air output port comprises a rear output port aperture fluidly connected to a second inner hollow portion of the second hollow supply tube.

10. The integrated air supply system of claim 9, wherein the at least one front air output port comprises a front output port aperture fluidly connected to a third inner hollow portion of the third hollow supply tube.

11. The integrated air supply system of claim 1, wherein the at least one hollow supply tube is supported by at least one support tube.

12. The integrated air supply system of claim 1, wherein the air supply is coupled to the at least one air input port by an input hose having an air filter.

13. A method of supplying air to a forced air helmet, the method comprising:
supplying air into at least one air input port and through at least one hollow supply tube, the at least one hollow supply tube forming a portion of a cage or chassis of a vehicle;
directing the air through the at least one hollow supply tube and through at least one air output port; and
flowing the air into a forced air helmet.

14. The method of claim 13, wherein the cage or chassis comprises a first hollow supply tube, a second hollow supply tube and a third hollow supply tube.

15. The method of claim 14, further comprising coupling the at least one air input port to one end of the first hollow supply tube.

16. The method of claim 15, wherein the at least one air output port comprises at least one rear air output port and at least one front air output port.

17. The method of claim 16, further comprising coupling the at least one rear air output port to the second hollow supply tube.

18. The method of claim 17, further comprising coupling the at least one front air output port to the third hollow supply tube.

19. The method claim 18, wherein the at least one air input port comprises an input port internal aperture.

20. The method of claim 19, further comprising fluidly connecting the input port internal aperture to a first inner hollow portion of the first hollow supply tube.
